(19) United States
(12) Patent Application Publication
(10) Pub. No.: US 2024/0136528 A1
(43) Pub. Date: Apr. 25, 2024

(54) ELECTRODE SHEET AND ELECTROCHEMICAL DEVICE

(71) Applicant: ZHUHAI COSMX BATTERY CO., LTD., Zhuhai (CN)

(72) Inventors: Kongyan Xie, Zhuhai (CN); Chong Peng, Zhuhai (CN); Jian Zhang, Zhuhai (CN)

(21) Appl. No.: 18/401,131

(22) Filed: Dec. 29, 2023

Related U.S. Application Data
(63) Continuation-in-part of application No. PCT/CN2022/130199, filed on Nov. 7, 2022.
Application No. PCT/CN2022/130199 is a continuation-in-part of application No. PCT/CN2022/130200, filed on Nov. 7, 2022.

(30) Foreign Application Priority Data
Nov. 29, 2021 (CN) 202111439176.3
Nov. 29, 2021 (CN) 202111449088.1

(51) Int. Cl. H01M 4/62; H01M 4/13; H01M 10/0525

(52) U.S. Cl. CPC H01M 4/622; H01M 4/13; H01M 10/0525

(57) ABSTRACT

This application provides an electrode sheet and an electrochemical device. The electrode sheet includes a substrate. The substrate includes a current collector and a protective layer provided on a surface of the current collector. An active material layer is further provided on the protective layer. The protective layer includes a non-active material including an inorganic material. The inorganic material has a weight loss rate of a measured by a thermogravimetric analysis, where 0.1%≤a≤10%, a=(m₀−m₁)/m₀, m₀ is a mass of the inorganic material before the thermogravimetric analysis, and m₁ is a mass of the inorganic material after the thermogravimetric analysis. The mass after the thermogravimetric analysis is a mass of the inorganic material when its temperature is raised from 25±5° C. to 900±20° C. at a heating rate of 20±2° C./min under an inert atmosphere.

### CROSS-REFERENCE TO RELATED APPLICATIONS

This application is a continuation-in-part of International Application No. PCT/CN2022/130199, filed on Nov. 7, 2022, which claims the priority to the Chinese patent application No. 202111449088.1, entitled “ELECTRODE SHEET AND ELECTROCHEMICAL DEVICE” and filed with the China National Intellectual Property Administration on Nov. 29, 2021 and International Application No. PCT/CN2022/130200, filed on Nov. 7, 2022, which claims the priority to the Chinese patent application No. 202111439176.3, entitled “ELECTRODE SHEET AND ELECTROCHEMICAL DEVICE” and filed with the China National Intellectual Property Administration on Nov. 29, 2021. All of the aforementioned applications are hereby incorporated by reference in their entireties.

### TECHNICAL FIELD

This application relates to an electrode sheet and an electrochemical device, belonging to the field of electrochemical energy storage devices.

### BACKGROUND

Electrochemical devices such as lithium-ion batteries have been widely used in energy storage such as consumer electronics and electric vehicles. Lithium-ion batteries have the advantages of high platform voltage, high energy density, no memory effect, and long life, which are widely used in smartphones, laptops, Bluetooth, wearable devices, etc. However, electrochemical devices such as lithium-ion batteries are inevitably subject to mechanical destroy such as needle puncture and heavy object impact. Short circuits are prone to take place when the electrochemical devices are subjected to the mechanical damages, releasing a plenty of heat in a short period of time, and resulting in failure due to fire and serious safety hazards. Especially, if a current collector of one of the positive electrode sheet and the negative electrode sheet is in contact with that of the other one (such as the current collector of the positive electrode sheet being in contact with the negative electrode sheet), a short circuit will occur, which will lead to greater safety risks. Therefore, how to reduce the risk of the short circuits and improve the safety and other performances of the electrochemical devices is an urgent technical problem to be solved by those skilled in the art.

### SUMMARY

This application provides an electrode sheet, which has good safety and other performances, and may effectively solve the problems in existing technologies of short circuits between a positive electrode sheet and a negative electrode sheet that are prone to occur, as well as the resulting poor safety and other performances of an electrochemical device.

In one aspect of this application, an electrode sheet is provided, which includes a substrate. The substrate includes a current collector and a protective layer disposed on a surface of the current collector. An active material layer is further provided on the protective layer. The protective layer includes a non-active material, and the non-active material includes an inorganic material. The inorganic material has a weight loss rate a measured by a thermogravimetric analysis, where 0.1%≤a≤10%, a=(m₀−m₁)/m₀, m₀ is a mass of the inorganic material before the thermogravimetric analysis, and m₁ is a mass of the inorganic material after the thermogravimetric analysis. The mass after the thermogravimetric analysis is a mass of the inorganic material when its temperature is raised from 25±5° C. to 900±20° C. at a heating rate of 2±2° ° C./min under an inert atmosphere.

According to an embodiment of this application, the protective layer further includes a conductive agent and a binder, and a mass percentage of the non-active material is 60%-96%, a mass percentage of the conductive agent is 1% to 10%, and a mass percentage of the binder is 3% to 30% based on a total mass of the protective layer.

According to an embodiment of this application, the inorganic material includes at least one of oxide, carbide, nitride, inorganic salt, and first carbon encapsulated material. The first carbon encapsulated material includes a first base material and a first carbon layer disposed on a surface of the first base material. The first base material includes at least one of oxide, carbide, nitride, and inorganic salt. The oxide includes at least one of alumina, titanium oxide, magnesium oxide, zirconium oxide, Kermesite, barium oxide, manganese oxide, and silicon oxide. The carbide includes metal carbide and/or non-metal carbide, where the metal carbide includes at least one of titanium carbide, calcium carbide, chromium carbide, tantalum carbide, vanadium carbide, zirconium carbide, and tungsten carbide, and the non-metal carbide includes boron carbide and/or silicon carbide. The nitride includes metal nitride and/or non-metal nitride, where the metal nitride includes at least one of lithium nitride, magnesium nitride, aluminum nitride, titanium nitride, and tantalum nitride, and the non-metal nitride includes at least one of boron nitride, triphosphorus pentanitride, and trisilicon tetranitride. The inorganic salt includes carbonate and/or sulfate.

According to an embodiment of this application, the non-active material further includes an organic material, and the organic material includes at least one of polystyrene, polymethyl methacrylate, polytetrafluoroethylene and a second carbon encapsulated material. The second carbon encapsulated material includes a second base material and a second carbon layer disposed on a surface of the second base material, and the second base material includes at least one of polystyrene, polymethyl methacrylate, and polytetrafluoroethylene.

According to an embodiment of this application, the inorganic material has a thermal decomposition temperature greater than or equal to 1200° C.

According to an embodiment of this application, a relationship between a thickness H1 of the protective layer and a particle diameter of the non-active material satisfies: H1≥2×D50, where D50 is a particle diameter when a volume of the non-active material accumulates to 50% starting from smaller particle diameters in a volume-based particle diameter distribution.

According to an embodiment of this application, the particle diameter of the non-active material satisfies: D50≤2 μm, D90≤5 μm. D50 is a particle diameter when a volume of the non-active material accumulates to 50% starting from smaller particle diameters in a volume-based particle diameter distribution; and D90 is a particle diameter when a volume of the non-active material accumulates to 90% starting from smaller particle diameters in a volume-based particle diameter distribution. Preferably, D50 is 0.05 μm-1 μm, and D90 is 1 μm-3 μm.

According to an embodiment of this application, the thickness of the protective layer is H1, and a thickness of the active material layer is H2, H1/H2≤1/5.

According to an embodiment of this application, the thickness of the protective layer is 0.1 μm-10 μm.

According to an embodiment of this application, both surfaces of the current collector are provided with the protective layer.

According to an embodiment of this application, both surfaces of the substrate are provided with the active material layer.

According to an embodiment of this application, the active material layer includes an active material, a conductive agent and a binder, and the protective layer further includes a binder. The binder in the protective layer has a content greater than the binder in the active material layer.

According to an embodiment of this application, the electrode sheet is a positive electrode sheet or a negative electrode sheet.

According to an embodiment of this application, a vertical distance from the protective layer to an outer edge of the current collector is smaller than a vertical distance from the active material layer to the outer edge of the current collector on at least one of a first end and a second end of the electrode sheet. The first end is opposite to the second end.

According to an embodiment of this application, an uncoated foil area is disposed between the protective layer and the outer edge of the current collector on at least one of a first end and a second end of the electrode sheet. The active material layer includes a first part and a second part connected to the first part. The first part is disposed on a surface of the protective layer, and the second part is disposed on a surface of the current collector in the uncoated foil area.

According to an embodiment of this application, in the inorganic material, an iron element has a content of a₁, a sodium element has a content of b₁, a potassium element has a content of c₁, and a calcium element has a content of d₁, where a₁≤100 ppm, b₁≤400 ppm, c₁≤100 ppm, and d₁≤400 ppm.

According to an embodiment of this application, the binder includes at least one of polyvinylidene fluoride, carboxylic acid-modified polyvinylidene fluoride, polymethyl methacrylate, polyacrylonitrile, polyacrylates, and polyimide, where the carboxylic acid-modified polyvinylidene fluoride includes acrylic acid-modified polyvinylidene fluoride.

According to an embodiment of this application, the conductive agent includes at least one of conductive carbon black, acetylene black, graphite, graphene, carbon nanotubes, and carbon nanofibers.

Another aspect of this application provides an electrochemical device, including the above-mentioned electrode sheet.

In this application, the protective layer and the active material layer are sequentially stacked on the surface of the current collector of the electrode sheet, and the inorganic material with a thermal weight loss rate satisfying 0.1%≤a≤10% is introduced into the protective layer. In the event of needle puncture or other situations in the electrochemical device, good thermal stability can be maintained, reducing the occurrence of side reactions, maintaining the stability of the electrode sheet, and significantly improving the safety performance of the electrochemical device. Specifically, the qualification rate of the needle puncture test of the electrochemical device is significantly improved. The probability of failure due to fire of the electrochemical device is greatly reduced. At the same time, the non-active materials as fillers are introduced into the protective layer and the non-active materials do not participate in the electrochemical reaction of the electrochemical device, which may reduce the impact on the cycle stability and other performances of the electrochemical device. In addition, the contents of iron element, sodium element, potassium element and calcium element in the inorganic material may be controlled to satisfy: a₁≤100 ppm, b₁≤400 ppm, c₁≤100 ppm, and d₁≤400 ppm respectively, which may improve the safety and electronic performance of the electrochemical device. As a result, the safety of the electrochemical device may be significantly improved in this application, and the problems may be effectively solved, such as failure due to fire and other problems caused by the electrochemical devices such as lithium-ion batteries being mechanically misused. Meanwhile, the cycling performance and other performances of the batteries are maintained to be basically not affected. That is, while improving the safety of the electrochemical device, the cycling performance of the electrochemical device may be maintained or even improved, which is of great significance to practical industrial applications.

### BRIEF DESCRIPTION OF DRAWINGS

FIG. 1 is a schematic structural diagram of an electrode sheet in an embodiment of this application.

FIG. 2 is a schematic structural diagram of an electrode sheet in another embodiment of this application.

Explanation of reference signs: 01: current collector; 02: protective layer; 03: active material layer.

### DESCRIPTION OF EMBODIMENTS

In order to enable those skilled in the art to better understand the solution of this application, this application will be described in further detail below. The specific embodiments listed below only describe the principle and features of this application, and the examples listed are only used to explain this application and do not limit the scope of this application. Based on the embodiments of this application, all other embodiments obtained by those skilled in the art without creative efforts fall within the protection scope of this application.

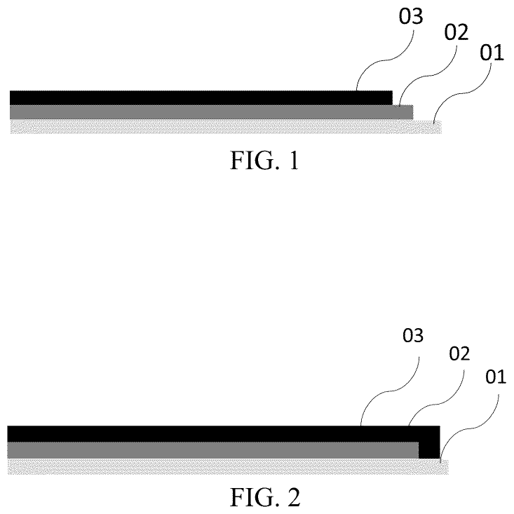

As shown in FIG. 1 and FIG. 2, the electrode sheet of this application includes a substrate. The substrate includes a current collector 01 and a protective layer 02 provided on a surface of the current collector 01. An active material layer 03 is further disposed on the protective layer 02. The protective layer 02 includes a non-active material, and the non-active material includes an inorganic material. The inorganic material has a weight loss rate a measured by a thermogravimetric analysis, 0.1%≤a≤10%, a=(m₀−m₁)/m₀, where m₀ is a mass of the inorganic material before the thermogravimetric analysis (that is, a mass without the thermogravimetric analysis), and m₁ is a mass of the inorganic material after the thermogravimetric analysis. The mass after the thermogravimetric analysis is a mass of the inorganic material when its temperature is raised from 25±5° C. to 900±20° C. at a heating rate of 2±2° ° C./min under an inert atmosphere.

The iron element has a content of a₁, the sodium element has a content of b₁, the potassium element has a content of c₁, and the calcium element has a content of d₁ in the inorganic material, where a₁≤100 ppm, b₁≤400 ppm, c₁≤100 ppm, and d₁≤400 ppm.

In specific implementation, the mass after the thermogravimetric analysis (or thermal weight-loss analysis) may be a mass of the inorganic material when its temperature is raised from room temperature to about 900° C. at a heating rate of about 20° C./min under an inert atmosphere, where the values such as the temperature and the heating rate are within an operation range of normal errors in this field.

In this application, conventional thermogravimetric analyzers and conventional methods in this field are used to perform a thermogravimetric (TGA) analysis on the materials to obtain the weight loss rate of the materials. During a specific implementation, an own iron spoon of the thermogravimetric analyzer is cleaned for placing the sample. The TGA analysis process is generally as follows: recording an initial mass of the material powder sample (that is, the mass before heating) as m₀; placing the powder sample into an analysis furnace of the thermogravimetric analyzer protected by the inert atmosphere using the iron spoon; performing a temperature-programmed rise at a heating rate of 20±2° C./min; recording a mass of the powder sample m₁ when the temperature is raised to 900±20° C.; and obtaining the weight loss rate of the material according to a=(m₀−m₁)/m₀. The inert atmosphere includes, for example, nitrogen.

For example, the weight loss rate a measured by the TGA analysis for the above-mentioned inorganic material may be 0.1%, 0.5%, 1%, 2%, 3%, 4%, 5%, 6%, 7%, 8%, 9%, 10% or in a range composed of any two of them.

In general, the inorganic material contains an impurity element, and the impurity element includes at least one of iron element, sodium element, potassium element and calcium element. The performances of the electrode sheet and the electrochemical device will be affected if the content of the impurity element is too high. For example, if the content of the iron element is too high, it is easy to cause local micro short circuits inside the electrochemical device/cell, and puncture of a separator located in the short-circuit position, affecting the safety and other performances of the electrochemical device. In this application, the protective layer is provided on the surface of the current collector, and the non-active material is introduced into the protective layer. Meanwhile, the contents of iron element, sodium element, potassium element and calcium element in the inorganic material may be controlled to satisfy: a₁≤100 ppm, b₁≤400 ppm, c₁≤100 ppm and d₁≤400 ppm, which may ensure exertion of the protective function of the protective layer on the electrode sheet and improve the safety and other performances of the electrode sheet and the electrochemical device.

The content of the impurity element in the inorganic material may be measured using a conventional instrument and method in this field in this application. For example, inductively coupled plasma mass spectrometry (ICP-MS) may be used for measurement. In specific implementation, the inorganic material sample to be tested may be injected into a plasma light source through an atomizer, and vaporized under a high-temperature condition. When the ionized gas is dissociated, it is separated according to the mass-to-charge ratio of the ions. The content of each element in the inorganic material is determined by analyzing peak intensity of ion of each element.

In this application, at least one of front and back surfaces of the current collector 01 is provided with the protective layer 02. When only one surface of the current collector 01 is provided with the protective layer 02, the protective layer 02 is provided with the active material layer 03, and the other surface of the current collector 01 may be provided with the active material layer or no active material layer. When each of the front and back surfaces of the current collector 01 is provided with the protective layer 02, the active material layer 03 is provided on the protective layer on at least one of the front and back surfaces of the current collector 01. That is, the protective layer 02 on one surface of the current collector 01 is provided with the active material layer 03, or the protective layers 02 on both surface of the current collector 01 are provided with the active material layers 03 respectively. Relatively speaking, the protective layers 02 are provided on both surfaces of the current collector 01 respectively, which is conducive to further improving the safety of the electrode sheet. The active material layers 03 are provided on both surfaces of the substrate, which is conducive to improving the energy density and other performances of the electrode sheet. Therefore, in some preferred embodiments, both surfaces of the current collector 01 are each provided with the protective layer 02, and both surfaces of the substrate are each provided with the active material layer 03.

In this application, the non-active material plays a supporting role in the protective layer 02, which serves as a skeleton support of the protective layer 02 and is generally the main component of the protective layer 02. If the content of the non-active material in the protective layer 02 is too small, the structural stability of the entire protective layer 02 will be poor, which is prone to be crushed under pressure during a rolling process in the preparation of the electrode sheet or to be damaged by extrusion during use of the electrode sheet. Therefore, the non-active material in the protective layer 02 has a mass content greater than 50%, further not less than 60%, for example, 60%-96%.

In addition, the protective layer 02 may further include a conductive agent and a binder. The binder is configured to bond the non-active material, the conductive agent and other components in the protective layer 02 together to form a coating, and to bond the protective layer 02 with the current collector 01 together to further improve the stability of the protective layer 02 and the bonding force between the protective layer 02 and the current collector 01, thereby improving the stability and safety and other performance of the electrode sheet. The conductive agent may build an electronic conductive network, especially may act as an electronic path connecting the current collector 01 and the active material layer 03 when the protective layer 02 is located between the surface of the current collector 01 and the active material layer 03, which facilitates the function of the current collector 01 and improves the rate capability and other performances of the electrode sheet. If the mass content of the binder in the protective layer 02 is too small, the bonding force between the particles in the protective layer 02 and the bonding force between the protective layer 02 and the current collector 01 are affected. If the mass content of the binder is too large, the electrode sheet will become brittle and a compacted density of the electrode sheet will be reduced, affecting the energy density of the electrode sheet. In addition, the conductive agent in the protective layer 02 provides a certain electronic conductivity for the protective layer 02. If the mass content of the conductive agent is too low, the conductive performance of the protective layer 02 will be insufficient and the electrical performance of the electrode sheet will be affected. If the mass content of the conductive agent is too large, the protection of the electrode sheet by the protective layer 02 will be affected to a certain extent. For example, when the electrode sheet used in an electrochemical device is short-circuited with the electrode sheet with the other polarity, the protective layer 02 of the electrode sheet has higher conductivity; when the electrode sheet is in contact with the electrode sheet with the other polarity, heat will be generated violently at the short circuit site, causing thermal runaway. Considering these factors comprehensively, in some preferred embodiments, the non-active material may have a mass percentage of 60%-96%, the conductive agent may have a mass percentage of 1%-10%, and the binder may have a mass percentage of 3%-30% based on the total mass of the protective layer 02. That is, the mass contents of the non-active material, the conductive agent, and the binder are 60%-96%, 1%-10%, and 3%-30% respectively in the protective layer 02. In a possible implementation, the mass content of the non-active material is, for example, in a range of 60%, 65%, 70%, 75%, 80%, 85%, 90%, 96%, or a range composed of any two of them in the protective layer 02. The mass content of the conductive agent is, for example, 1%, 2%, 3%, 4%, 5%, 6%, 7%, 8%, 9%, 10%, or in a range composed of any two of them in the protective layer 02. The mass content of the binder is, for example, 3%, 7%, 10%, 15%, 20%, 25%, 30%, or in a range composed of any two of them in the protective layer 02. Preferably, the non-active material in the protective layer 02 has a mass content greater than the binder in the protective layer 02, and the binder in the protective layer 02 has a mass content greater than the conductive agent in the protective layer 02.

In this application, the non-active material is a material that does not participate in the electrochemical reactions during the charging and discharging process of the electrode sheet/electrochemical device (relative to the function of the active material in the active material layer of the electrode sheet), which may ensure the electrochemical stability of the protective layer 02, will not continue to deteriorate during the charging and discharging process of the electrode sheet and thus affect the service life of the electrode sheet. Meanwhile, the non-active material also serves as a skeleton support of the protective layer. In some embodiments, the inorganic material in the protective layer 02 may include at least one of oxide, carbide, nitride, inorganic salt, and a first carbon encapsulated material. The first carbon encapsulated material includes a first base material, and a first carbon layer disposed on a surface of the first base material. The first base material includes at least one of oxide, carbide, nitride, and inorganic salt, where the oxide includes at least one of alumina (Al₂O₃), titanium oxide, magnesium oxide (MgO), zirconium oxide (ZrO), Kermesite (Sb₂S₂O), barium oxide (BaO), manganese oxide, and silicon oxide; and the carbide includes metal carbide and/or non-metal carbide. The metal carbide includes at least one of titanium carbide, calcium carbide, chromium carbide, tantalum carbide, vanadium carbide, zirconium carbide, and tungsten carbide; and the non-metal carbide includes boron carbide and/or silicon carbide. The nitride includes metal nitride and/or non-metal nitride. The metal nitride includes at least one of lithium nitride, magnesium nitride, aluminum nitride, titanium nitride, and tantalum nitride; and the non-metal nitride includes at least one of boron nitride, triphosphorus pentanitride and trisilicon tetranitride. The inorganic salt includes carbonate and/or sulfate.

In this application, the above-mentioned inorganic material usually has good thermal stability and high thermal decomposition temperature. In some embodiments, the inorganic material in the protective layer 02 has a thermal decomposition temperature greater than or equal to 1200° C. For example, the material with a thermal decomposition temperature greater than or equal to 1200° C. may be selected, such as alumina, titanium oxide, magnesium oxide, manganese oxide, silicon oxide, etc. The inorganic material with a larger thermal decomposition temperature may be selected in order to enable the protective layer 02 to maintain good stability in a wider temperature range, and further improve the safety and other performances of the electrode sheet and the electrochemical device. A decomposition reaction, that occurs when the temperature is higher than a normal temperature or under heating, is called a thermal decomposition. The thermal decomposition temperature generally refers to a temperature when the material begins to decompose. The thermal decomposition temperature of the inorganic material in this application may be measured according to a conventional method in this field. For example, a thermogravimetric analyzer may be used to perform a thermogravimetric analysis for the inorganic material. Specifically, the inorganic material are heated from room temperature (25±5° C.) at a heating rate of about 20° C./min under an inert atmosphere to obtain a thermogravimetric analysis (TG) curve. The TG curve has an abscissa indicating a temperature, and an ordinate indicating a remaining mass of material during the heating process. Generally, a temperature corresponding to a first inflection point of the TG curve is the thermal decomposition temperature of material. During a specific implementation, the own iron spoon of the thermogravimetric analyzer is cleaned for placing samples. The thermogravimetric analysis process is generally as follows: placing the powder sample into an analysis furnace of the thermogravimetric analyzer protected by the inert atmosphere using the iron spoon; performing a temperature programmed-rise at a heating rate of 20±2° C./min to obtain the TG curve, where the inert atmosphere includes, for example, nitrogen.

In some embodiments, the inorganic material in the protective layer 02 has a Vickers microhardness (or micro-Vickers hardness) greater than or equal to 3.5 GPa, which is beneficial for maintaining a basic shape of the protective layer 02 when the protective layer 02 is subjected to extrusion (such as extrusion generated during a rolling process when preparing the electrode sheet or extrusion received during use of the electrode sheet), making it better to maintain its original shape, and avoiding the local protective layer 02 being extruded excessively and thus detached from the current collector 01, which causes a short circuit of the current collector 01 in contact with the electrode sheet with the other polarity in the electrochemical device, thereby improving the safety and other performances of the electrode sheet and the electrochemical device. For example, the materials with a Vickers microhardness greater than or equal to 3.5 GPa may be selected, such as alumina, titanium oxide, magnesium oxide, manganese oxide, silicon oxide, etc.

In this application, conventional methods in the field may be used to measure the Vickers microhardness of the material. For example, the Vickers microhardness of the material is measured using a Vickers microhardness tester under the conditions of a load of about 4.91N and a holding time of about 10 s. The Vickers microhardness may be measured at least three times, and then an average of the results of at least three measurements is taken as a final Vickers microhardness value of the material to be tested. In a specific implementation, the material to be tested is in a powder form, and at least three powder samples may be collected from the material. Then the Vickers microhardness of each sample is measured alone, and the average of the measurement results corresponding to all powder samples is calculated to obtain the Vickers microhardness of the material to be tested.

In addition, the above-mentioned non-active material may further include an organic material, and the organic material may be fine particles formed of polymer material. The organic material includes at least one of polystyrene, polymethyl methacrylate, polytetrafluoroethylene, and a second carbon encapsulated material. The second carbon encapsulated material includes a second base material and a second carbon layer disposed on a surface of the second base material. The second base material includes at least one of polystyrene, polymethyl methacrylate, and polytetrafluoroethylene.

In this application, the first carbon encapsulated material may be a composite material obtained by coating the first carbon layer on the surface of the first base material through a carbon coating process; and the second carbon encapsulated material may be a composite material obtained by coating the second carbon layer on the surface of the second base material through a carbon coating process. The carbon coating process is a common process in this field and will not be described in further detail.

Specifically, the above-mentioned non-active material is in the form of granules, the inorganic material is inorganic particle, and the organic material is organic particle. The non-active material with small particle diameter are not prone to be removed from the surface of the current collector 01 during mechanical actions such as nail penetration and needle puncture, further improving the stability and safety of the electrode sheet. In some preferred embodiments, the particle diameter of the non-active material satisfies: D50≤2 μm, D90≤5 μm. D50 is a particle diameter when a volume of the non-active material accumulates to 50% starting from smaller particle diameters in a volume-based particle diameter distribution; and D90 is a particle diameter when a volume of the non-active material accumulates to 90% starting from smaller particle diameters in a volume-based particle diameter distribution. Preferably, D50 is 0.05 μm-1 μm, such as 0.05 μm, 0.1 μm, 0.2 μm, 0.3 μm, 0.4 μm, 0.5 μm, 0.6 μm, 0.7 μm, 0.8 μm, 0.9 μm, 1 μm or in a range composed of any two of them; D90 is 1 μm-3 μm, such as 1 μm, 1.5 μm, 2 μm, 2.5 μm, 3 μm or in a range composed of any two of them.

According to the researches of this application, a relationship between a thickness H1 of the protective layer 02 and a particle diameter of the non-active material satisfies H1≥2×D50. This condition is conductive to at least two non-active material particles evenly distributed in a thickness direction of the protective layer 02 (a direction perpendicular to the surface of the current collector 01), which is equivalent to forming at least two single-layer protective layers 02 (the non-active material particles in each single-layer protective layer 02 have an average number of 1 in its thickness direction), and is more beneficial for developing the function of the protective layer 02 and improving the safety and other performances of the electrode sheet.

After further researches, the thickness of the protective layer 02 is H1, and the thickness of the active material layer 03 is H2, where H1/H2≤1/5, preferably H1/H2≤1/10, which may improve the safety of the electrochemical device while maintaining its higher energy density and other performances.

In some embodiments, the thickness of the protective layer 02 may be 0.1 μm-10 μm, such as 0.1 μm, 0.5 μm, 1 μm, 2 μm, 3 μm, 4 μm, 5 μm, 6 μm, 7 μm, 8 μm, 9 μm, 10 μm, or in a range composed of any two of them.

In some embodiments, the protective layer 02 may have a resistivity of 500-5000 Ω·cm. The resistivity of the protective layer 02 is the result of a combination of multiple factors such as the thickness of the protective layer 02, the mass content of the conductive agent, and a type of the non-active material. If the resistivity of the protective layer 02 is too large, the electrical performance of the electrode sheet and the electrochemical device will be affected; if the resistivity of the protective layer 02 is too small, the safety of the electrode sheet and the electrochemical device will be affected. The resistivity of the protective layer 02 is controlled to be 500-5000 Ω·cm, which may balance the safety and the electrical performance of the electrochemical device.

Generally, the above-mentioned active material layer 03 includes an active material, a conductive agent and a binder. The binder in the protective layer 02 has a content greater than the binder in the active material layer 03, which is conducive to further improving the stability, safety and cycling performance of the electrode sheet simultaneously.

In a possible implementation, each of the binders in the protective layer 02 and the active material layer 03 includes at least one of polyvinylidene fluoride (PVDF), carboxylic acid-modified polyvinylidene fluoride (PVDF), polymethyl methacrylate (PMMA), polyacrylonitrile (PAN), polyacrylates, and polyimide (PI), where the carboxylic acid-modified PVDF includes acrylic acid-modified PVDF. The binders in the protective layer 02 and the active material layer 03 may be the same or different. In some preferred embodiments, the binder in the protective layer 02 includes carboxylic acid-modified PVDF, and more preferably includes acrylic acid-modified PVDF.

In a possible implementation, each of the conductive agents in the protective layer 02 and the active material layer 03 includes at least one of conductive carbon black, acetylene black, graphite, graphene, carbon nanotubes, and carbon nanofibers. The conductive agents in the protective layer 02 and the active material layer 03 may be the same or different.

In addition, the active material layer may further include a dispersant, such as sodium carboxymethyl cellulose.

In this application, the above-mentioned electrode sheet may be a positive electrode sheet or a negative electrode sheet. The active material in the active material layer 03 is a material that participates in the electrochemical reaction during the charging and discharging process of the electrode sheet/electrochemical device. When the above-mentioned electrode sheet is the positive electrode sheet, the active material layer 03 is a positive active material layer 03, where the active material is a positive electrode active material, such as a positive electrode active material that provides lithium ions. The positive electrode active material may include at least one of lithium positive electrode composite metal oxides (that is, an inorganic material containing lithium), such as lithium cobalt oxide (LiCoO₂), lithium nickel oxide (LiNiO₂), lithium manganate (LiMn₂O₄), lithium iron phosphate (LiFePO₄), and ternary materials. The ternary material may have a chemical formula of LiNiₓCo_{y}Mn_{z}O₂, where x+y+z=1. The ternary material includes, for example, nickel-cobalt-manganese ternary material and/or nickel-cobalt-aluminum ternary material, etc. When the above-mentioned electrode sheet is a negative electrode sheet, the above-mentioned active material layer 03 is a negative active material layer 03, where the active material is a negative electrode active material. The negative electrode active material may include at least one of artificial graphite, natural graphite, soft carbon, hard carbon, mesophase carbon microball (MCMB), silicon, silicon-carbon composite, silicon oxide material, lithium titanate, and lithium metal.

In addition, when the above-mentioned electrode sheet is a positive electrode sheet, the above-mentioned current collector 01 is a positive current collector, which may be an aluminum foil composed of aluminum as a main component, or a composite current collector formed by laminating an aluminum foil and other materials (such as polymer materials, etc.) together, or a composite current collector including an aluminum foil and a conductive carbon layer coated on a surface of the aluminum foil, where a mass content of the aluminum is generally not less than 95% in the aluminum foil. When the above-mentioned electrode sheet is a negative electrode sheet, the above-mentioned current collector 01 is a negative current collector, including, for example, copper foil, etc.

Preferably, the active material layer 03 is disposed on the surface of the protective layer 02 (that is, the protective layer 02 is located between the surface of the current collector 01 and the active material layer 03) in this application. The active material layer 03 may cover part of the protective layer 02 (as shown in FIG. 1), or the active material may layer 03 cover the protective layer 02 completely (as shown in FIG. 2). Specifically, in some embodiments, as shown in FIG. 1, a vertical distance from the protective layer 02 to an outer edge of the current collector 01 is smaller than a vertical distance from the active material layer 03 to the outer edge of the current collector 01 on at least one of a first end and a second end of the electrode sheet; that is, the distance from the protective layer 02 to the outer edge of the current collector 01 in a direction parallel to a direction from the first end to the second end is smaller than the distance from the active material layer 03 to the outer edge of the current collector 01 in the direction parallel to the direction from the first end to the second end; the first end is opposite to the second end; an orthographic projection of the protective layer 02 on the surface of the current collector 01 generally covers an orthographic projection of the active material layer 03 on the surface of the current collector 01. In other embodiments, as shown in FIG. 2, an uncoated foil area is disposed between the protective layer 02 and the outer edge of the current collector 01 at one end or both ends from the first end and the second end of the electrode sheet. The active material layer 03 includes a first part and a second part connected to the first part. The first part is disposed on the surface of the protective layer 02 and the second part is disposed on the surface of the current collector 01 in the uncoated foil area (that is, the second part is located on a surface of current collector 01 that is between the protective layer 02 and the outer edge of the current collector 01), where the first end is opposite to the second end.

The electrode sheet of this application further includes a tab. The tab may be provided at a conventional location where the tab is provided in this field. For example, the tab may be provided at an end of the electrode sheet (such as at least one of the above-mentioned first end and second end), or provided in the middle of the electrode sheet. The electrode sheet of this application may be produced by conventional methods in the field such as a coating method. During a specific implementation, raw materials of the protective layer 02 may be mixed with a first solvent to prepare a first slurry, and then the first slurry may be coated at a preset position of the surface of the current collector 01 to form the protective layer 02 after drying, obtaining the above-mentioned substrate. Raw materials of the active material layer 03 are mixed with a second solvent to prepare a second slurry, and then the second slurry is coated at a preset position of the surface of the substrate, followed by drying, rolling and other process to give the active material layer 03. The tab is then welded to a preset location for the tab to form an electrode sheet. The preset position for the tab may be reserved during the above-mentioned coating process, or the coating at the preset position for the tab may be cleaned off after the operation of coating is completed, and then the tab may be welded at the preset position for the tab. The first solvent and the second solvent may be the same or different, and may include, for example, N-methylpyrrolidone (NMP).

The electrochemical device of this application includes the above-mentioned electrode sheet. Specifically, the electrochemical device of this application may include a positive electrode sheet with the above-mentioned structural design (that is, the above-mentioned electrode sheet is a positive electrode sheet), or a negative electrode sheet with the above-mentioned structural design (that is, the above-mentioned electrode sheet is a negative electrode sheet), or both a positive electrode sheet with the above structural design and a negative electrode sheet with the above structural design (that is, the above-mentioned electrode sheet includes a positive electrode sheet and a negative electrode sheet). When the above-mentioned electrode sheet is a positive electrode sheet, the above-mentioned electrochemical device further includes a negative electrode sheet, which may be a conventional negative electrode sheet in this field. When the above-mentioned electrode sheet is a negative electrode sheet, the above-mentioned electrochemical device further includes a positive electrode sheet, which may also be a conventional positive electrode sheet in this field. This application is not specifically limited to these.

Specifically, the electrochemical device of this application may be a battery, such as a lithium-ion battery. Generally, the electrochemical device includes an electrolyte, a cell, and a packaging material for sealing the cell. The cell includes a positive electrode sheet, a negative electrode sheet, and a separation film (or separator) located between the positive electrode sheet and the negative electrode sheet. The electrochemical device may be prepared according to conventional methods in the field, for example, the above-mentioned positive electrode sheet, separation film, and negative electrode sheet are stacked in sequence and then rolled or laminated to form a cell, and then the electrochemical device is prepared through packing the cell with the packaging materials (such as aluminum laminated film, etc.), injecting the electrolyte, sealing, formation process, etc.

In a possible implementation, the above-mentioned electrolyte may include a non-aqueous electrolyte, and its components may include a non-aqueous solvent and a lithium salt. The non-aqueous solvent includes carbonates and/or carboxylates, and the lithium salt includes lithium hexafluorophosphate (LiPF₆) and/or lithium tetrafluoroborate (LiBF₄). In addition, the electrolyte may further include an additive, and conventional electrolyte additives in this field may be used, which is not specifically limited in this application.

In a possible implementation, the separation film may include a base film. The base film includes, for example, at least one of a PE film formed of polyethylene (PE), a PP film formed of polypropylene (PP), and a PI film formed of polyimide (PI). In addition, a reinforcement layer may further be provided on a surface of the base film as needed. The reinforcement layer may include a binder layer and/or a ceramic layer. The binder layer includes a binder, and the ceramic layer includes ceramic particles. Relatively speaking, the binder layer is introduced into the separation film, which may improve the adhesion of the separation film; and the ceramic layer is introduced into the separation film, which may improve the heat resistance and other performances of the separation film. The ceramic layer may further include a binder to facilitate bonding the ceramic particles to form the ceramic layer and improve the bonding force between the ceramic layer and the base film. The binders in the binder layer and the ceramic layer may each include at least one of polytetrafluoroethylene, polyurethane, polyvinylidene fluoride, polyimide, polyacrylonitrile, polymethyl methacrylate, styrene-butadiene rubber, lithium polystyrene sulfonate, epoxy resin, styrene-acrylic latex, polyacrylic acid, and polyethylene oxide. The binders in the binder layer and the ceramic layer may be the same or different. The ceramic particles in the ceramic layer may include at least one of alumina, magnesium oxide, boehmite, magnesium hydroxide, barium sulfate, barium titanate, zirconium oxide, magnesium aluminate, silicon oxide, hydrotalcite, tourmaline, zinc oxide, calcium oxide, and fast ion nanoparticles.

In order to make the purpose, technical solutions and advantages of this application clearer, the technical solutions of this application will be clearly and completely described below in conjunction with specific embodiments. Obviously, the described embodiments are part of the embodiments, not all of the embodiments of this application. Based on the embodiments of this application, all other embodiments obtained by those skilled in the art without creative efforts fall within the protection scope of this application.

In the following embodiments, the TGA analysis is performed on the inorganic material using a thermogravimetric analyzer to obtain the weight loss rate of the inorganic material. The analysis process is briefly described as follows: recording an initial mass of the material powder sample (that is, the mass before heating) as m₀; placing the powder sample into an analysis furnace of the thermogravimetric analyzer protected by nitrogen using a clean iron spoon; performing a temperature-programmed rise at a heating rate of 20° C./min; recording a mass of the powder sample m₁ when the temperature is raised to 900° C. (m₁ is a mass of the inorganic material when its temperature rises from room temperature at a heating rate of 20° C./min to 900° C. in an inert atmosphere); obtaining the weight loss rate of the material according to an equation: a=(m₀−m₁)/m₀. The room temperature is 25±5° C.

In the following embodiments, the thermal decomposition temperature of the inorganic material is measured using a thermogravimetric analyzer. The testing process is as follows: placing the powder sample into the analysis furnace, that is protected by nitrogen, of the thermogravimetric analyzer using a clean iron spoon; performing a temperature-programmed rise at a heating rate of 20° C./min to obtain a TG curve. The temperature corresponding to the first inflection point of the TG curve is the thermal decomposition temperature of the inorganic material (that is, the temperature when the inorganic material begins to decompose).

In the following embodiments, the contents of iron element (Fe), sodium element (Na), potassium element (K) and calcium element (Ca) in the inorganic material are measured using a ICP-MS. The testing process is described briefly as follows: the inorganic material sample to be tested is injected into a plasma light source through an atomizer, and vaporized under a high-temperature condition. When ionized gas is dissociated, it is separated according to mass-to-charge ratio of the ion. The content of each element in the inorganic material is determined by analyzing peak intensity of ion of each element.

### Example 1

1. Preparation of a Positive Electrode Sheet

Alumina, acrylic modified PVDF and carbon black were mixed at a mass ratio of 62:30:8 (that is, the alumina has a mass content of about 62%, the acrylic modified PVDF has a mass content of about 30%, and the carbon black has a mass content of about 8% in the protective layer formed); NMP was added and stirred evenly to prepare a first slurry; the first slurry was applied to front and back surfaces of an aluminum foil, followed by drying to form a protective layer, thereby obtaining a substrate.

LCO (lithium cobalt oxide), PVDF, and carbon black were mixed at a mass ratio of 96:2:2; NMP was added and stirred evenly to prepare a second slurry; the second slurry was applied to both the front and back surfaces of the substrate (i.e., the surfaces of the protective layers disposed on both the front and back surfaces of the aluminum foil), followed by drying and rolling to form a positive active material layer; a tab for positive electrode was welded at a preset position of the aluminum foil for the tab to obtain the positive electrode sheet.

The weight loss rate a and the thermal decomposition temperature, that are measured by TGA analysis, of the alumina used are shown in Table 2 and Table 3 respectively. In the inorganic material, the iron element has a content of a₁, the sodium element has a content of b₁, the potassium element has a content of c₁, and the calcium element has a content of d₁, which are shown in Table 4. The alumina has a D50 of 0.7 μm, and a D90 of 1.2 μm; the protective layer has a thickness H1 of 2 μm; and the positive active material layer has a thickness H2 of 60 μm.

2. Preparation of a Negative Electrode Sheet

Artificial graphite, styrene-butadiene rubber, sodium carboxymethyl cellulose, and carbon black were mixed with water in a mass ratio of 96:1.5:1.5:1, and stirred evenly to make a negative electrode slurry; the negative electrode slurry was applied to both the front and back surfaces of a copper foil, followed by drying and rolling to form a negative active material layer; a tab for negative electrode was welded at a preset position of the copper foil for the tab to obtain the negative electrode sheet.

3. Preparation of a Lithium-Ion Battery

The above-mentioned positive electrode sheet, separation film, and negative electrode sheet were stacked in sequence and then rolled into a bare cell. The bare cell was packaged with an aluminum laminated film. The electrolyte was injected through a sealing port, followed by sealing the sealing port and formation, etc., to obtain the lithium-ion battery.

Referring to the preparation process in Example 1, the positive electrode sheets, negative electrode sheets and lithium ion batteries of Example 2 to Example 9, Comparative Example 1 to Comparative Example 12 are obtained.

The differences of Examples 2-5 and Comparative Examples 1-4 from Example 1 lie in the mass contents of alumina, acrylic modified PVDF, and carbon black in the protective layers of the positive electrode sheets, seeing Table 1 for details, with the remaining conditions being basically the same as those in Example 1.

The difference of Comparative Example 5 from Example 1 lies in that the positive electrode sheet is not provided with a protective layer (that is, only with the positive active material layer), with the remaining conditions being basically the same as Example 1.

The difference of Examples 6-7, and Comparative Examples 6-7 from Example 1 lies in the thermal weight loss rate a, that is measured by the TGA analysis, of the alumina used to form the protective layer of the positive electrode sheet, seeing Table 2 for details, with the remaining conditions being basically the same as Example 1.

The difference of Examples 8-9 and Comparative Example 8 from Example 1 lies in the thermal decomposition temperature of the alumina used to form the protective layer of the positive electrode sheet, with the remaining conditions being basically the same as Example 1.

The difference of Comparative Examples 9-12 from Example 1 lies in the content of the iron element a₁, the content of the sodium element b₁, the content of the potassium element c₁ and the content of the calcium element d₁ used in forming the protective layer of the positive electrode sheets, seeing Table 4 for details, with the remaining conditions being basically the same as Example 1.

Performance tests are performed for the batteries of each example and comparative example using conventional performance testing methods in this field. Results are shown in Table 1 and Table 2. The testing process is briefly described as follows.

(1) Needle puncture test: fully charging the battery, placing the fully charged battery on a needle puncture test equipment, and then starting the equipment so that a needle with a diameter of 3 mm penetrates into a center of the battery in a direction perpendicular to a battery plane at a speed of 130 mm/s; standing for 10 min and then removing the needle off. The battery without causing fire is recorded as qualified, and ten batteries are tested for each group. The qualification rate of the needle puncture test is equivalent to N₁/10, where N₁ is the number of the battery that is recorded as qualified in the needle puncture test.

(2) Rate capability test: discharging the battery to 3.0V at a rate of 0.5 C, charging the battery to an upper limit voltage at a rate of 0.5 C after standing for 5 min; then charging at a constant voltage with a cut-off current of 0.02 C; discharging the battery to 3.0V at a rate of 0.2 C after standing for 5 min, and recording the battery capacity as C0; charging the battery to the upper limit voltage at a rate of 0.5 C after standing for 5 min, and then charging at a constant voltage with a cut-off current of 0.02 C; discharging the battery to 3.0V at a rate of 0.5 C after standing for 5 min, and recording the battery capacity as C1. C1/C0 is a ratio of the discharge capacity under 0.5 C to the discharge capacity under 0.2 C, which is used to evaluate the rate discharge capability of the battery.

(3) Energy density test: fully charging the battery, then discharging to 3.0V at a rate of 0.2 C. The discharged energy is recorded as E and the volumetric energy density of the battery is expressed as ED=E/V, where V is a volume of the battery. V is obtained by measuring a length L, a width W, and a height H, and V=L×W×H.

TABLE 1

| | Mass content of each | | | | Qualification | | |
|---|---|---|---|---|---|---|---|
| | component in the | | | Thickness | rate in the | | |
| | protective layer | | | of the | needle | Rate | Energy |
| | | | Carbon | protective | puncture test | capability | density loss |
| Example | Alumina | PVDF | black | layer | (N₁/10) | (C1/C0) | ΔED* |
| Example 1 | 62% | 30% | 8% | 2 μm | 10/10 | 98.2% | 2.5% |
| Example 2 | 70% | 23% | 7% | 2 μm | 10/10 | 98.0% | 2.1% |
| Example 3 | 80% | 15% | 5% | 2 μm | 10/10 | 98.0% | 2.1% |
| Example 4 | 90% | 7.5% | 2.5% | 2 μm | 10/10 | 97.8% | 1.8% |
| Example 5 | 96% | 3.9% | 0.1% | 2 μm | 10/10 | 96.0% | 2.3% |
| Comparative | 50% | 45% | 5% | 2 μm | 10/10 | 98.0% | 4.5% |
| Example 1 | | | | | | | |
| Comparative | 62% | 20% | 18% | 2 μm | 1/10 | 98.5% | 2.1% |
| Example 2 | | | | | | | |
| Comparative | 92% | 2% | 6% | 2 μm | 3/10 | 98.2% | 2.0% |
| Example 3 | | | | | | | |
| Comparative | 92% | 7.5% | 0.5% | 2 μm | 10/10 | 50.0% | 60% |
| Example 4 | | | | | | | |
| Comparative | / | / | / | / | 0/10 | 98.3% | 0% |
| Example 5 | | | | | | | |

*represents that ΔED refers to the difference between the volumetric energy density of the battery of this example and the volumetric energy density ED of the battery of Comparative Example 5.

TABLE 2

| | Weight loss rate a | Qualification rate |
|---|---|---|
| | of the alumina in | in the needle |
| Example | the protective layer | puncture test (N1/10) |
| Example 1 | 0.5% | 10/10 |
| Example 6 | 3.5% | 10/10 |
| Example 7 | 8.4% | 10/10 |
| Comparative Example 6 | 12.1% | 8/10 |
| Comparative Example 7 | 18.0% | 6/10 |

TABLE 3

| | Thermal decomposition | Qualification rate |
|---|---|---|
| | temperature of the alumina | in the needle |
| Example | in the protective layer | puncture test (N1/10) |
| Example 1 | 1800° C. | 10/10 |
| Example 8 | 1500° C. | 10/10 |
| Example 9 | 1200° C. | 10/10 |
| Comparative | 750° C. | 4/10 |
| Example 8 | | |

TABLE 4

| | | | | | Qualification | |
|---|---|---|---|---|---|---|
| | Contents of the impurity elements in | | | | rate in the | Whether the |
| | the alumina of the protective layer/ | | | | needle | electronic |
| | ppm | | | | puncture test | performance |
| Example | Fe | Na | K | Ca | (N₁/10) | is affected? |
| Example 1 | 8.24 | 378.52 | 43.84 | 197.91 | 10/10 | No |
| Comparative | 209.57 | 283.47 | 53.63 | 108.47 | 9/10 | Yes |
| Example 9 | | | | | | |
| Comparative | 19.83 | 721.47 | 38.27 | 206.39 | 8/10 | Yes |
| Example 10 | | | | | | |
| Comparative | 9.27 | 231.79 | 384.74 | 220.89 | 9/10 | Yes |
| Example 11 | | | | | | |
| Comparative | 7.65 | 284.90 | 49.87 | 593.62 | 6/10 | Yes |
| Example 12 | | | | | | |

It can be seen from Example 1 to Example 5 and Comparative Example 5 that providing the above protective layer may significantly improve the safety of the battery, while maintaining good rate capability, energy density and other performances.

It can be seen from Example 1 and Comparative Example 1 that excessive binder in the protective layer will affect a compaction density of the positive electrode sheet, thereby leading to a loss in the energy density of the battery.

It can be seen from Example 1 and Comparative Example 2 that excessive conductive agent in the protective layer will reduce the qualification rate in the needle puncture test and affect the safety of the battery.

It can be seen from Example 1 and Comparative Example 3 that too less binder in the protective layer will cause a poor adhesiveness of the protective layer, reduce the qualification rate in the needle puncture test, and affect the safety of the battery.

It can be seen from Example 1 and Comparative Example 4 that too less conductive agent in the protective layer will cause poor electronic conductivity of the protective layer, lead to poor rate discharge capability of the battery and affect the electrical performance of the battery.

It can be seen from Example 1, Example 6 to Example 7, and Comparative Example 6 to Comparative Example 7 that the inorganic materials (alumina) with different weight loss rates in the protective layer have an important influence on the safety of the electrode sheet and the electrochemical device. The safety of the electrode sheet and the battery may be effectively improved using the inorganic materials with a weight loss rate satisfying 0.1% a≤10%. In addition, it is found by testing that the results of the rate capability test and the energy density loss test for Example 6 to Example 7 are basically equivalent to those for Example 1, which further indicates that the energy density and rate capability and other performance of the battery may be maintained simultaneously by introducing the inorganic material that meets the above weight loss rate into the protective layer on the surface of the current collector.

It can be seen from Example 1, Example 8 to Example 9, and Comparative Example 8 that the inorganic materials (alumina) with different thermal decomposition temperatures in the protective layer have an important influence on the safety of the electrode sheet and the electrochemical device. The safety of the electrode sheet and the battery may be effectively improved using the inorganic material with a thermal decomposition temperature being not less than 1200° C. In addition, it is found by testing that the results of the rate capability test and the energy density loss test for Example 8 to Example 9 are basically equivalent to those for Example 1, which further indicates that the energy density and rate capability and other performance of the battery may be maintained simultaneously by introducing the inorganic material with a thermal decomposition temperature being not less than 1200° C. into the protective layer on the surface of the current collector.

It can be seen from Example 1 and Comparative Examples 9-12 that the contents of Fe, Na, K and Ca in the inorganic material (alumina) of the protective layer have significant impact on the safety and electronic performance of the electrode sheet and the electrochemical device. The contents of iron element, sodium element, potassium element and calcium element in the inorganic material of the protective layer are controlled to satisfy: a₁≤100 ppm, b₁≤400 ppm, c₁≤100 ppm, and d₁≤400 ppm respectively, which may significantly improve the safety of the electrode sheet and the electrochemical device. In addition, through testing, the rate capability, cycle performance, high-temperature performance, low-temperature performance, and the other electronic performances of the battery in Example 1 are much better than those in Comparative Examples 9-12, indicating that too high contents of iron element, sodium element, potassium element and calcium element in the inorganic material will affect the electronic performances of the battery.

In addition, the positive electrode sheet of Example 1 has the structure of FIG. 1. Through testing, it is found that when the positive electrode sheet of Example 1 has the structure of FIG. 2, it may achieve a basically same effect as the positive electrode sheet with the structure of FIG. 1, which will not be described again.

The embodiments of this application have been described above. However, this application is not limited to the above-described embodiments. Any modifications, equivalent substitutions, improvements, etc. made within the spirit and principles of this application shall be included in the protection scope of this application.

What is claimed is:

1. An electrode sheet, comprising a substrate, wherein the substrate comprises a current collector and a protective layer provided on a surface of the current collector; an active material layer is further provided on the protective layer; the protective layer comprises a non-active material comprising an inorganic material; the inorganic material has a weight loss rate a measured by a thermogravimetric analysis, 0.1%≤a≤10%, a=(m₀−m₁)/m₀, m₀ is a mass of the inorganic material before the thermogravimetric analysis, and m₁ is a mass of the inorganic material after the thermogravimetric analysis; the mass after the thermogravimetric analysis is a mass of the inorganic material when its temperature is raised from 25±5° C. to 900±20° C. at a heating rate of 20±2° C./min under an inert atmosphere.

2. The electrode sheet according to claim 1, wherein the protective layer further comprises a conductive agent and a binder, and a mass percentage of the non-active material is 60%-96%, a mass percentage of the conductive agent is 1% to 10%, and a mass percentage of the binder is 3% to 30% based on a total mass of the protective layer.

3. The electrode sheet according to claim 1, wherein the inorganic material comprises at least one of oxide, carbide, nitride, inorganic salt, and first carbon encapsulated material;
the first carbon encapsulated material comprises a first base material and a first carbon layer disposed on a surface of the first base material; the first base material comprises at least one of oxide, carbide, nitride, and inorganic salt; wherein the oxide comprises at least one of alumina, titanium oxide, magnesium oxide, zirconium oxide, Kermesite, barium oxide, manganese oxide, and silicon oxide; the carbide comprises at least one of metal carbide and non-metal carbide, wherein the metal carbide comprises at least one of titanium carbide, calcium carbide, chromium carbide, tantalum carbide, vanadium carbide, zirconium carbide, and tungsten carbide, and the non-metal carbide comprises at least one of boron carbide and silicon carbide; the nitride comprises at least one of metal nitride and non-metal nitride, wherein the metal nitride comprises at least one of lithium nitride, magnesium nitride, aluminum nitride, titanium nitride, and tantalum nitride, and the non-metal nitride comprises at least one of boron nitride, triphosphorus pentanitride, and trisilicon tetranitride; the inorganic salt comprises at least one of carbonate and sulfate; and/or
the non-active material further comprises an organic material, and the organic material comprises at least one of polystyrene, polymethyl methacrylate, polytetrafluoroethylene and a second carbon encapsulated material; the second carbon encapsulated material comprises a second base material and a second carbon layer disposed on a surface of the second base material, and the second base material comprises at least one of polystyrene, polymethyl methacrylate, and polytetrafluoroethylene.

4. The electrode sheet according to claim 2, wherein the inorganic material comprises at least one of oxide, carbide, nitride, inorganic salt, and first carbon encapsulated material;
the first carbon encapsulated material comprises a first base material and a first carbon layer disposed on a surface of the first base material; the first base material comprises at least one of oxide, carbide, nitride, and inorganic salt; wherein the oxide comprises at least one of alumina, titanium oxide, magnesium oxide, zirconium oxide, Kermesite, barium oxide, manganese oxide, and silicon oxide; the carbide comprises at least one of metal carbide and non-metal carbide, wherein the metal carbide comprises at least one of titanium carbide, calcium carbide, chromium carbide, tantalum carbide, vanadium carbide, zirconium carbide, and tungsten carbide, and the non-metal carbide comprises at least one of boron carbide and silicon carbide; the nitride comprises at least one of metal nitride and non-metal nitride, wherein the metal nitride comprises at least one of lithium nitride, magnesium nitride, aluminum nitride, titanium nitride, and tantalum nitride, and the non-metal nitride comprises at least one of boron nitride, triphosphorus pentanitride, and trisilicon tetranitride; the inorganic salt comprises at least one of carbonate and sulfate; and/or
the non-active material further comprises an organic material, and the organic material comprises at least one of polystyrene, polymethyl methacrylate, polytetrafluoroethylene and a second carbon encapsulated material; the second carbon encapsulated material comprises a second base material and a second carbon layer disposed on a surface of the second base material, and the second base material comprises at least one of polystyrene, polymethyl methacrylate, and polytetrafluoroethylene.

5. The electrode sheet according to claim 1, wherein the inorganic material has a thermal decomposition temperature greater than or equal to 1200° C.

6. The electrode sheet according to claim 2, wherein the inorganic material has a thermal decomposition temperature greater than or equal to 1200° C.

7. The electrode sheet according to claim 1, wherein
a relationship between a thickness H1 of the protective layer and a particle diameter D50 of the non-active material satisfies H1≥2×D50; and/or,
a particle diameter of the non-active material satisfies: D50≤2 μm, D90≤5 μm.

8. The electrode sheet according to claim 7, wherein
the particle diameter of the non-active material satisfies: D50 is 0.05 μm-1 μm, and D90 is 1 μm-3 μm.

9. The electrode sheet according to claim 1, wherein
a thickness of the protective layer is H1, a thickness of the active material layer is H2, H1/H2≤1/5; and/or,
a thickness of the protective layer is 0.1 μm-10 μm.

10. The electrode sheet according to claim 7, wherein
a thickness of the protective layer is H1, a thickness of the active material layer is H2, H1/H2≤1/5; and/or,
a thickness of the protective layer is 0.1 μm-10 μm.

11. The electrode sheet according to claim 1, wherein
both surfaces of the current collector are provided with the protective layer; and/or
both surfaces of the substrate are provided with the active material layer; and/or
the active material layer comprises an active material, a conductive agent and a binder, and the protective layer further comprises a binder; the binder in the protective layer has a content greater than the binder in the active material layer.

12. The electrode sheet according to claim 1, wherein
a vertical distance from the protective layer to an outer edge of the current collector is smaller than a vertical distance from the active material layer to the outer edge of the current collector on at least one of a first end and a second end of the electrode sheet, the first end being opposite to the second end; or,
an uncoated foil area is disposed between the protective layer and an outer edge of the current collector on at least one of a first end and a second end of the electrode sheet; the active material layer comprises a first part and a second part connected to the first part; the first part is disposed on a surface of the protective layer, and the second part is disposed on a surface of the current collector in the uncoated foil area.

13. The electrode sheet according to claim 1, wherein
in the inorganic material, an iron element has a content of a1, a sodium element has a content of b1, a potassium element has a content of c1, and a calcium element has a content of d1, and a1≤100 ppm, b1≤400 ppm, c1≤100 ppm, and d1≤400 ppm.

14. The electrode sheet according to claim 2, wherein
the binder comprises at least one of polyvinylidene fluoride, carboxylic acid-modified polyvinylidene fluoride, polymethyl methacrylate, polyacrylonitrile, polyacrylates, and polyimide, and the carboxylic acid-modified polyvinylidene fluoride comprises acrylic acid-modified polyvinylidene fluoride.

15. The electrode sheet according to claim 2, wherein
the conductive agent comprises at least one of conductive carbon black, acetylene black, graphite, graphene, carbon nanotubes, and carbon nanofibers.

16. The electrode sheet according to claim 11, wherein
the binder comprises at least one of polyvinylidene fluoride, carboxylic acid-modified polyvinylidene fluoride, polymethyl methacrylate, polyacrylonitrile, polyacrylates, and polyimide, and the carboxylic acid-modified polyvinylidene fluoride comprises acrylic acid-modified polyvinylidene fluoride.

17. The electrode sheet according to claim 11, wherein
the conductive agent comprises at least one of conductive carbon black, acetylene black, graphite, graphene, carbon nanotubes, and carbon nanofibers.

18. An electrochemical device, comprising the electrode sheet according to claim 1.
